(19) United States
(12) Patent Application Publication
(10) Pub. No.: US 2007/0016680 A1
(43) Pub. Date: Jan. 18, 2007

(54) Method and system for proxy-based file sharing

(76) Inventors: Gary S. Burd, Kirkland, WA (US); David Bau, Gladwyne, PA (US); Roderick Adonis Chavez, Kirkland, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,392

(22) Filed: Jun. 30, 2005

(51) Int. Cl. G06F 15/16

(52) U.S. Cl. 709/227

(57) ABSTRACT

In one embodiment, a method for proxy-based file sharing is described. The method comprises establishing a peer to peer connection with a remote client through a server using a file sharing application at the remote client, generating a document having a network address, receiving a file from the remote client through the file sharing application, posting the received file on the document, and sending the document with the posted file to a second remote client. Other embodiments are also disclosed.

### TECHNICAL FIELD

At least some embodiments of the present invention relate to communication systems in general, and more particularly to proxy-based file sharing.

### BACKGROUND

The Internet provides a versatile communication channel for various machines and communication devices to communicate with each other. Many applications have been developed to use the Internet to meet various communication needs. For example, with the surge in the use of the Internet, there has been a simultaneous increase in the ways to communicate electronically, such as via email and instant messaging (IM). These ways to communicate electronically are relatively fast, convenient, and confidential.

Currently, applications exist that allow peer-to-peer file sharing. With peer-to-peer file sharing, two users may move data back and forth directly between both parties. Typically for peer-to-peer file sharing both users must have a client application to enable the file sharing running locally on their computers.

The requirement that both users have a copy of the file sharing application installed on their terminal may be problematic. For instance, this may prevent a user from sharing files with another user until the other user is able to download and install the file-sharing application. Sometimes a user may not have the capabilities or the desire to download a file-sharing application at their terminal, thus preventing file-sharing with another user. Therefore, the ability to directly share files over a network without the use of a file sharing application would be beneficial.

### SUMMARY

In one aspect of the present invention, proxy-based file sharing is performed. In one embodiment, a method for proxy-based file sharing is described. The method comprises establishing a peer to peer connection with a remote client through a server using a file sharing application at the remote client, generating a document having a network address, receiving a file from the remote client through the file sharing application, posting the received file on the document, and sending the document with the posted file to a second remote client.

In one embodiment, the server is an Extensible Messaging and Presence (XMPP) server. Furthermore, the file may be selected from the group including a graphics file, a music file, and a video file. In other embodiments, the document may be a HyperText Markup Language (HTML) page.

### BRIEF DESCRIPTION OF THE DRAWINGS

The appended claims set forth the features of the invention with particularity. The embodiments of the invention, together with its advantages, may be best understood from the following detailed description taken in conjunction with the accompanying drawings in which:

FIG. 1 illustrates an embodiment of an environment for client to client proxy-based file sharing;

FIG. 2 illustrates an embodiment of a process for proxy-based file sharing using a client system and a server system;

FIG. 3 illustrates an embodiment of a process for proxy-based file sharing;

FIG. 4 illustrates another embodiment of a process for proxy-based file sharing;

FIG. 5 illustrates an embodiment of a proxy-based file sharing environment;

FIG. 6 illustrates another embodiment of a proxy-based file sharing environment;

FIG. 7 illustrates an example of an embodiment of proxy-based file sharing;

FIG. 8 illustrates an embodiment of a server architecture; and

FIG. 9 illustrates an embodiment of a client architecture.

### DETAILED DESCRIPTION

Described below is a method and system for proxy-based file sharing. File sharing applications normally call for all participants in the file sharing to have a copy of the file sharing application installed on their terminal in order to share files. This may prevent a user from sharing files with another user until the other user is able to download and install the file-sharing application. In one embodiment of this invention, the user that has the file sharing application opens a peer-to-peer connection with a real-time communication server. The real-time communication server runs the file sharing application with the user and the user's terminal operates as if it was running a peer-to-peer connection with another user.

To allow the user to directly share files with the other user, the real-time communication server communicates with the other user using a common or standard communications program. In one example, the real-time communication server generates an HyperText Markup Language (HTML) page and gives it a Uniform Resource Locator (URL). The real-time communication server can send the URL in an e-mail or instant message to the other user or send the URL to the first user and the first user can send the URL to the other user.

When the other user receives the URL, it can access the page on the Buzz server using a web browser. The web page allows the files to be shared through the web browser application. Any file types that the web browser supports may be sent to the other user through the web page. The real-time communication server can emulate any or all of the file sharing application's functions through HTML/(HyperText Transport Protocol (HTTP). In other embodiments, more features can be added through Flash, Java, and other browser plug-ins. Another ubiquitous program, such as Windows Media Player, Realplayer, or QuickTime may be used instead of a browser depending on the type of file sharing application.

Embodiments of the invention introduce the concept of proxy-based file sharing as real-time file sharing using a server or other proxy for one or more real-time computer communication accounts in order to directly share files between two clients associated with the real-time communication accounts. Examples of communication accounts include instant messaging accounts, email accounts, and the like.

In one embodiment, one or more clients may connect with another client through a real-time communication account. These two clients may seek to share files with one another via a direction communication connection. The direct file sharing generally is implemented through special file sharing applications located at each client. However, one client may not have the special file sharing application and for a variety of reasons may not be able to download the application. Therefore, the ability to directly share files over a network without the use of a file sharing application would be beneficial.

In one embodiment, a client with a file sharing application establishes a relationship with another client without a file sharing application through a real-time communication server. The two clients may desire to directly share files. The client with the file sharing application sends content to share directly with the other client over the network. A proxy server may then recognize that the receiving client does not have the capability to receive the content because it does not possess a file sharing application of its own.

Therefore, the proxy server establishes a direct communication connection with the sending client. The proxy server posts the received shared content in a document. The document may be accessible through a network address. The proxy server then delivers the posted content on the document to the receiving client. In one embodiment, the receiving client may view the document with the posted content via a web browser interface. This web browser interface emulates the characteristics of the file sharing application located at the sending client. In other embodiments, the client without the file sharing application may also be able to send content to be shared to the client with the file sharing application through the web browser interface.

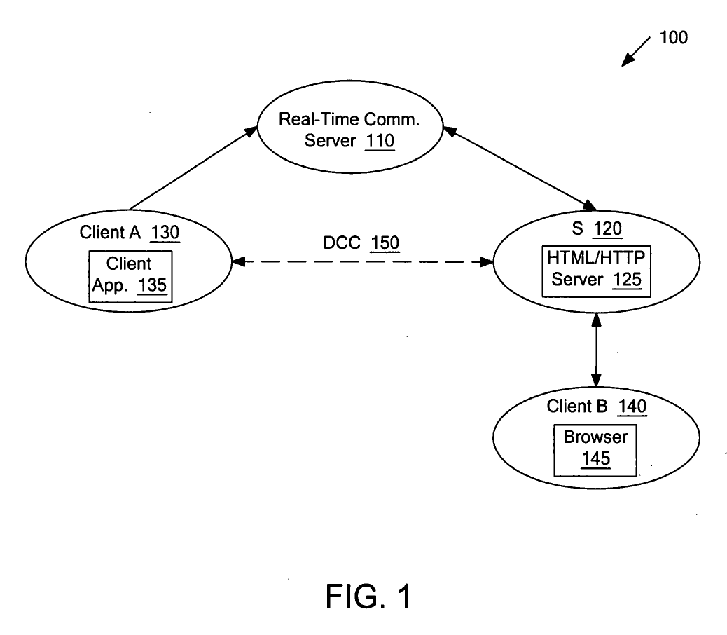

FIG. 1 illustrates an embodiment of an environment for proxy-based file sharing using a client system (client) and a server system (server). Environment 100 includes a real-time communication server 110, proxy server 120, client A 130, and client B 140. Real-time communication server 110, proxy server 120, client A 130, and client B 140 may all be communicatively coupled via a network.

In one embodiment, client A 130 includes a client application on its terminal to enable file sharing with another client. Conventionally, in order for client A 130 to share files with client B 140 via the client application 135, client B 140 would also need the file sharing application 135. Client A 130 and client B 140 could then establish a direct communication connection to share these files. However, in embodiments of the invention, client B 140 does not possess a file-sharing application to enable this file sharing. In some embodiments, Client B 140 possesses a browser application 145.

Embodiments of the invention enable file sharing between client A 130 and client B 140 even though client B 140 does not have a client application 135 for file sharing. Real-time communication server 110 provides, maintains, and manages real-time communication between clients A 130 and B 140. Once client A 130 has established that it wants to initiate file-sharing with client B 140, proxy server 120 may establish a direct communication connection 150 with client A 130. The proxy server 120 acts as the proxy connection for client B 140 with client A 130. Client A 130 may then send content it wishes to directly share with client B 140 to the proxy server 120 via the direct communication connection 150. Proxy server 120 may send the shared content in an accessible format to client B 140. Consequently, direct file sharing may be accomplished between clients A 130 and B 140 through the proxy. The direct communication connection 150 between client A 130 and proxy server 120 may be based on a direct communication protocol, such as a peer-to-peer communication protocol.

When client A 130 transfers the files to share via the direct communication connection 150, proxy server 120 may place the files received from client A 130 into a document, such as an Hypertext Markup Language (HTML) document, that can be viewed by client B 140 without the need for the client application 135 for file-sharing being located at client B 140. In one embodiment, proxy server 120 provides the document to be shared with client B 140 through a HTML/HyperText Transport Protocol (HTTP) server 125 located at the proxy server 120. As a result, the document may be viewed through the browser application 145 located at client B 140 as a web browser interface. In one embodiment, all of the code for the direct communication connection 150 with client A 130 is running at the proxy server 120, instead of at client B 140. However, client A 130 may not know that it is talking to client B 140 via a proxy server 120.

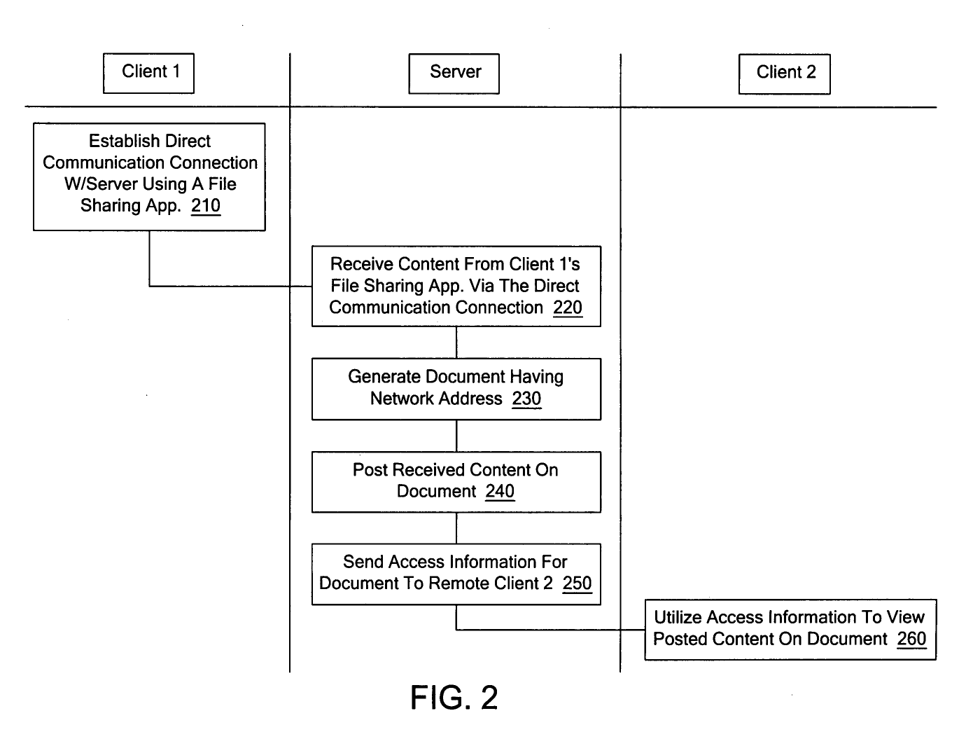

FIG. 2 illustrates an embodiment of a process for proxy-based file sharing using a client system and a server system. Two remote clients are in communication with a server over a network. A first remote client establishes a direct communication connection with the server by way of a file sharing application located at the first client 210. In one embodiment, the server acts as a proxy in the direct communication connection for the second remote client when it is determined that the second remote client does not have a file sharing application to share files with the first remote client. In one embodiment, the direct communication connection is based on a peer-to-peer communication protocol.

The server then receives content from the first remote client's file sharing application via the direct communication connection 220. The server generates a document having a network address associated with it at processing block 230. The received content from the first remote client is then posted to the document by the server 240. The server then sends access information for the document to the second remote client 250. Finally, the second remote client utilizes the access information sent to it by the server to view the posted content of the document 260.

In one embodiment, the first and second remote clients make initial contact through a real-time communication server. The real-time communication server enables the two clients to establish the direct communication connection. For example, the first and second clients may initiate contact through an instant messaging program. The real-time communication server is used as a control channel to help establish the necessary information to make a direct communication connection. When it is determined that a client does not have the applications for a direct communication file sharing session, then the proxy server is implemented to enable the file sharing.

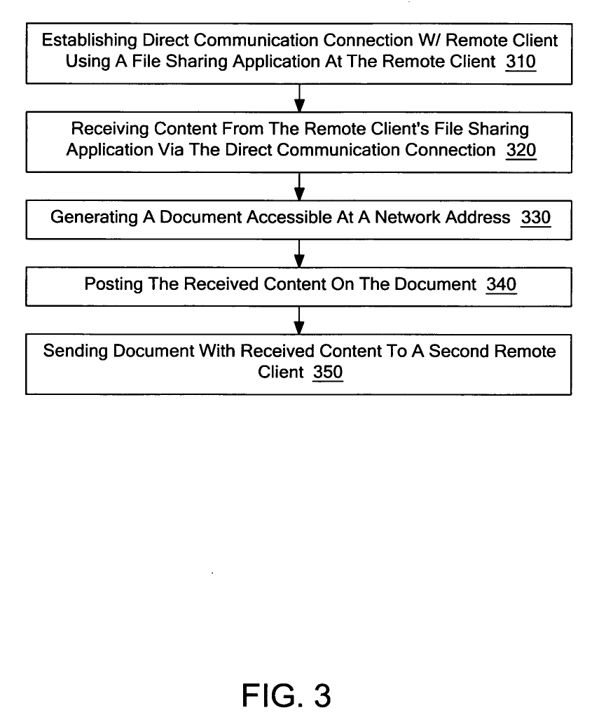

FIG. 3 illustrates an embodiment of a process for proxy-based file sharing. At processing block 310, a server establishes a direct communication connection with a remote client using a file sharing application at the remote client. Then, at processing block 320, content from the remote client's file sharing application is received at the server via the peer-to-peer connection.

The server then generates a document accessible at a network address at processing block 330. At processing block 340, the received content is posted to the document by the server. Finally, at processing block 350, the document with the received content is sent to a second remote client.

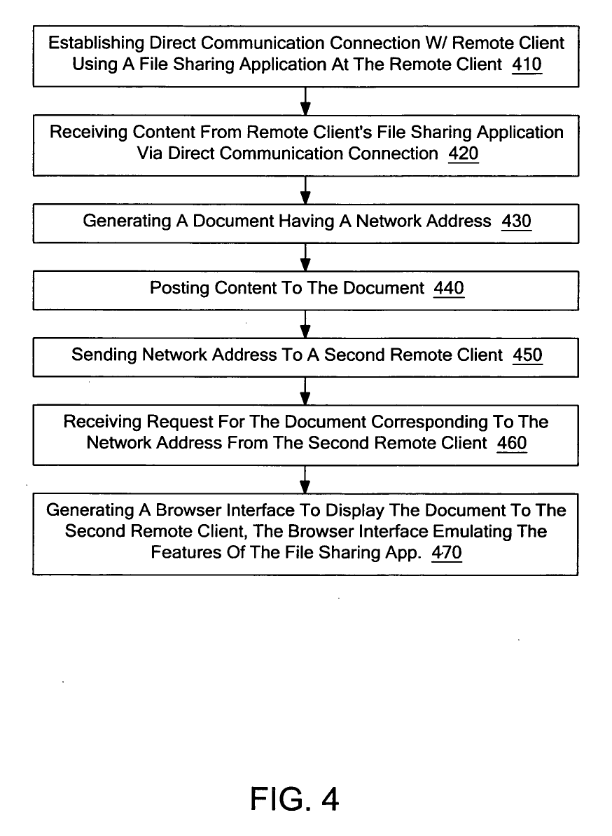

FIG. 4 illustrates another embodiment of a process for proxy-based file sharing. Processing blocks 410-440 are similar to processing block 310-340 of FIG. 3. However, processing blocks 450-470 of FIG. 4 elaborate on the procedure for sending a document with received content to a second remote client, as disclosed in processing block 350 of FIG. 3.

At processing block 450, the network address associated with the document is sent by the server to a second remote client. Then, at processing block 460, the server receives a request for the network address corresponding to the document from the second remote client. Finally, at processing block 470, the server generates a browser interface to display the document to the second remote client. In one embodiment, the browser interface emulates the features of the file sharing application located at the first remote client. This browser interface is viewed at the second remote client to enable file sharing with the first remote client.

### Environment/System

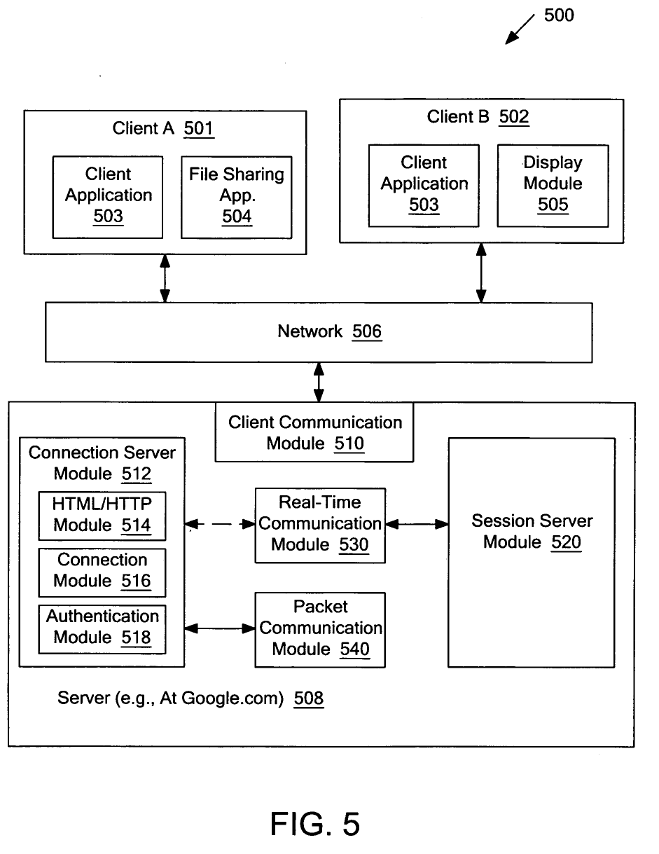

FIG. 5 illustrates an embodiment of a proxy-based file sharing environment 500. The environment 500 includes one or more client systems 501, 502. In one embodiment, each client 501, 502 may include a client application 503 to facilitate various tasks. The client application 503 may include a software application that is independently obtained (e.g., purchased from a shop) or downloaded on the client 501, 502 from the server. 508 (e.g., downloaded from a website, such as Google.com). Each client 501, 502 is in communication with the server 508 via a communication network 506, such as Local Area Network (LAN), wireless LAN, Wide Area Network (WAN), Metropolitan Area Network (MAN), Personal Area Network (PAN), Intranet, and the Internet.

In one embodiment, the server 508 includes one or more servers, such as a client communication server module 510, connection server module 512, session server module 520, and real-time communication module 530, to facilitate communication of information between the server 508 and clients 501, 502 and other servers. The server 508, via client communication module 510, provides open-standards based interoperable real-time communications service and deploys a core server architecture that is compatible with leading real-time communication standards, such as Extensible Messaging and Presence Protocol (XMPP) core and XMPP IM. The server 508 is also compatible with various existing Jabber protocols and clients, such as Trillian Pro (XP), Fire (OSX), GAIM (Linux), and the like, which provide several extensions to XMPP.

The server 508 supports client-to-client extensibility in presence, messaging, and IQ without modifying the server 508 and further supports deploying server extensions and applications without modifying the infrastructure. The server 508 additionally supports encryption of client-to-server communications, delegated user management for rosters, authentication, and other preferences. The server 508 may also support various email protocols to provide and support email communications. The server 508 may also include other servers and server modules, such as DeMilitarized Zone (DMZ) proxies, authentication services, storage, and web servers for HyperText Transport Protocol (HTTP)-based IM services (e.g., web-based chat and HTTP-based presence).

Connection server module 512 helps facilitate the Transmission Control Protocol/Internet Protocol (TCP/IP)-based connections to one or more clients 502. Session server module 520 helps maintain rosters at the clients 501, 502 and presence information and enforce XMPP policies. Both the connection server modules 512 and the session server modules 520 may be written in a programming language that is appropriate for the time, such as Java, C++, and the like, and may communicate with each other by exchanging streams of packets (e.g., protocol buffers) via the packet communication module 540. A packet includes an envelope with addressing, identifying, and typing information, and a payload with an XMPP stanza of eXtensible Markup Language (XML).

Connection server module 512 further includes one or more connection modules 516 to service a large number of simultaneously connections to clients 501, 502, authentication modules 518 to perform authentication of the clients 501, 502 as well as of the users accessing the clients 501, 502, and further includes one or more HyperText Markup Language (HTML)/HyperText Transport Protocol (HTTP) modules 514 to provide a browser interface to one or more clients 501, 502 via a browser application located at the one or more clients 501, 502. Connection server module 512 can perform initial version negotiation, authentication, and transport layer security (TLS) handshaking for a connection by parsing and analyzing the original XML stream from the client 501, 502. Connection server module 512 can also be used to protect the server 508 from XMPP protocol attacks.

The client application 503 helps facilitate communication between clients 501, 502 and the server 508. The client application 503 may include a communication mechanism (e.g., instant messaging, email, etc.) to help the user accessing the client 501, 502 to communicate with users at other clients via the server 508. Although the client application 503 may provide communication tools, the communication is managed at the server 508. In some embodiments, client 501 may include a file sharing application 504 to directly share files with other clients via a direct connection. Furthermore, client 502 may provide a display module 505 to help facilitate the display of the tools (e.g., web browser) for the user to access and use the communication account, as well as information or data provided as a document via the communication account.

A “document” as used herein broadly refers to various items, such as files, directories, or other data or information that may be stored, received, sent, created or otherwise processed by one or more computing devices. For example, a document may include any file created on a computing system. The term file as used herein includes a collection of bytes or bits stored as an individual entity. For example, a file may be a binary file, a text file, or a combination thereof, such as a word processor file, a data file, a spreadsheet, a workbook, an image, a drawing, an audio file, a video file, an audio/visual file, a multimedia file, an archive file, a batch file, a source file, an object file, or an executable program.

The term “file” may also refer to a file system object which is accessed as though the object were a file. A document may be linked to one or more other documents, such as via a hyperlink. A document may include a web page, such as a file coded in a markup language (e.g. HyperText Markup Language (HTML), XML, a file coded in a scripting language (e.g. JavaScript, Active Server Pages (ASP), and Perl), or a file viewed in a web browser (e.g. a portable document format (PDF), and an image file or text file). Examples of such web browsers include Microsoft Internet Explore®, Netscape Navigator®, and the like. A document may reside on a single system, or may be accessed by one or more systems via a network 506, such as an Intranet or the Internet.

A client 501 that includes a file sharing application 504 may wish to directly share files with another client 502. In one embodiment, client 501 may initially make contact with client 502 through real-time communication supported by the real-time communication module 530. For example, the clients 501, 502 may be included on each other's roster in an instant messaging program. Once initial contact is made, real-time communication module 530 facilitates the creation of a direct communication connection (e.g., peer-to-peer connection). In one embodiment, real-time communication module 530 may utilize packet communication module 540 to assist in establishing a direct communication connection.

However, if client 502 does not have a file sharing application 504 locally at its terminal, it will be unable to share files with client 501 via the direct communication connection. In one embodiment, server 508 acts as a proxy for client 502 in the direct communication connection. Server 508 may create the direct communication connection with the client 501 in order to receive the files that the client 501 wishes to share with client 502. Server 508 may receive the files to share and then, through connection server module 512, create an interface for client 502 to view the shared files.

In one embodiment, connection server module 512 may utilize HTML/HTTP module 514 to create a document that may be viewed through display module 505 at client 502. In some embodiments, connection server module 512 may automatically send the document to the client 502 for viewing. In other embodiments, connection server module 512 may send a link, such as a Uniform Resource Locator (URL), to a network address that contains the document for the client 502 to view. Client 502 may then access the document by way of the network address link.

In other embodiments, connection server module 512 creates a browser interface that emulates the file sharing application 504 for client 502 to view shared files. In some embodiments, client 502 may further share its own files with client 501 through this browser interface. Furthermore, additional features may be added to the browser interface through Flash, Java, and other browser plug-ins. In some embodiments, another ubiquitous program, such as Windows Media Player, Realplayer, or Quicktime may be used as display module 505 depending on the type of file sharing.

It is contemplated that both the server 508 and the clients 501, 502 are capable of supporting various protocols and standards, such as HTML, XML, Wireless Markup Language (WML), HTTP, Simple Mail Transfer Protocol (SMTP), Web Distributed Authority and Versioning (WebDAV), Simple Object Access Protocol (SOAP), Single Sign-On (SSO), Secure Sockets Layer (SSL), X.509, Unicode, and the like.

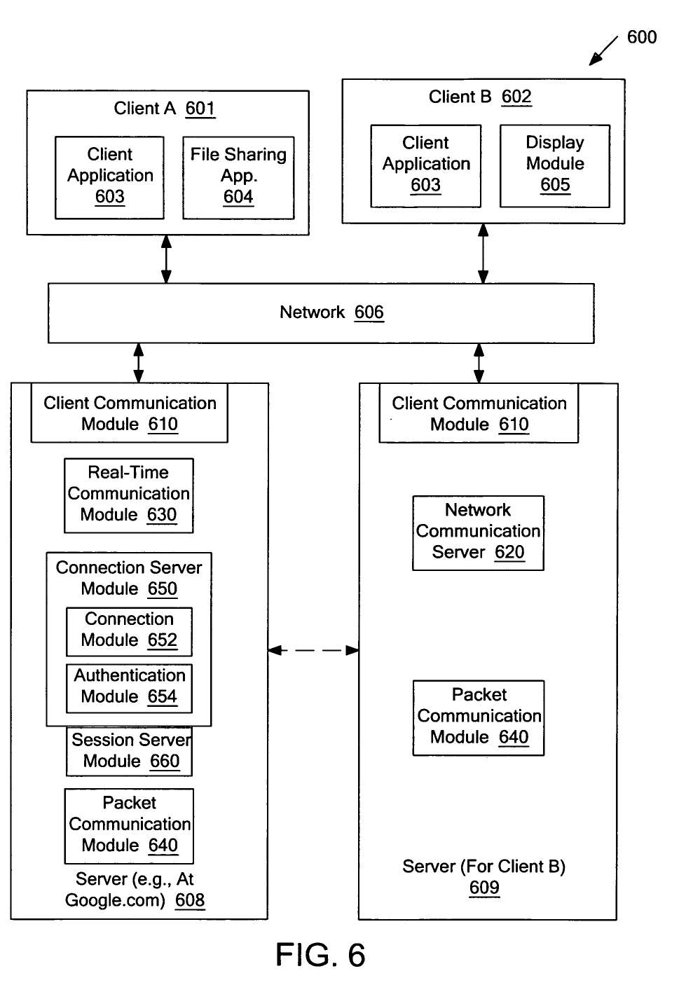

FIG. 6 illustrates another embodiment of a proxy-based file sharing environment 600. The environment 600 includes one or more client systems 601, 602. Client systems 601, 602 are the same as client systems 501, 502 described with respect to FIG. 5. Each client 601, 602 is in communication with servers 608, 609 via a communication network 606, such as Local Area Network (LAN), wireless LAN, Wide Area Network (WAN), Metropolitan Area Network (MAN), Personal Area Network (PAN), Intranet, and the Internet.

In one embodiment, server 608 is a central server for an organization. For example, server 608 may be a Google.com server. Server 608 includes one or more servers, such as client communication server module 610 and real-time communications server module 630, to facilitate communication of information between the server 608 and clients 601, 602 and other servers. The server 608, via client communication module 610, provides open-standards based interoperable real-time communications service and deploys a core server architecture that is compatible with leading real-time communication standards, such as Extensible Messaging and Presence Protocol (XMPP) core and XMPP IM. The server 608 is also compatible with various existing Jabber protocols and clients, such as Trillian Pro (XP), Fire (OSX), GAIM (Linux), and the like, which provide several extensions to XMPP.

The server 608 supports client-to-client extensibility in presence, messaging, and IQ without modifying the server 608 and further supports deploying server extensions and applications without modifying the infrastructure. The server 608 additionally supports encryption of client-to-server communications, delegated user management for rosters, authentication, and other preferences. The server 608 may also support various email protocols to provide and support email communications. The server 608 may also include other servers and server modules, such as DeMilitarized Zone (DMZ) proxies, authentication services, storage, and web servers for HyperText Transport Protocol (HTTP)-based IM services (e.g., web-based chat and HTTP-based presence).

Connection server module 650 helps facilitate the Transmission Control Protocol/Internet Protocol (TCP/IP)-based connections to one or more clients 601, 602. Session server module 660 helps maintain rosters at the clients 601, 602 and presence information and enforce XMPP policies. Both the connection server modules 650 and the session server modules 660 may be written in a programming language that is appropriate for the time, such as Java, C++, and the like, and may communicate with each other by exchanging streams of packets (e.g., protocol buffers) via the packet communication module 640. A packet includes an envelope with addressing, identifying, and typing information, and a payload with an XMPP stanza of eXtensible Markup Language (XML).

In one embodiment, server 609 is a server for one or more clients 601, 602. Server 609 includes one or more servers, such as client communication module 610 and network communications server module 620. In one embodiment, client communication module 610 in server 609 provides the same functionalities for server 609 as for server 608. In one embodiment, network communications server module 620 provides a browser interface to the one or more clients 601, 602. For example, network communications module 620 may provide a browser interface to be viewed by display module 605 at client 602. Server 609 further includes a packet communication module 640 similar to server 608 to allow for communication with another server or client by exchanging streams of packets (e.g., protocol buffers). In one embodiment, packet communication module 640 may enable a peer-to-peer connection.

In one embodiment, the modules of clients 601, 602 and both servers 608, 609 operate in a similar fashion to their counterparts described with respect to FIG. 5. However, in one embodiment servers 608 and 609 are physically separate, as depicted in FIG. 6. When client 601 seeks to create a direct communication connection with client 602 via real-time communication module 630, real-time communication module 630 may determine that client 602 is unable to participate in direct file sharing as client 602 does not possess a file sharing application 604.

As a result, server 608 creates a direct communication connection between client A 601 and server 610 through packet communication module 640. Client 601 may then send files to share with client 602 to server 609 by way of the direct communication connection. Server 609 may provide the shared files in an accessible interface to client 602 through the network communication server module 620. Client 602 may view the shared files in the display module 605 located at client 602. In some embodiments, client 602 may also share its own files with client 601 through the interface provided by server 609.

### EXAMPLE

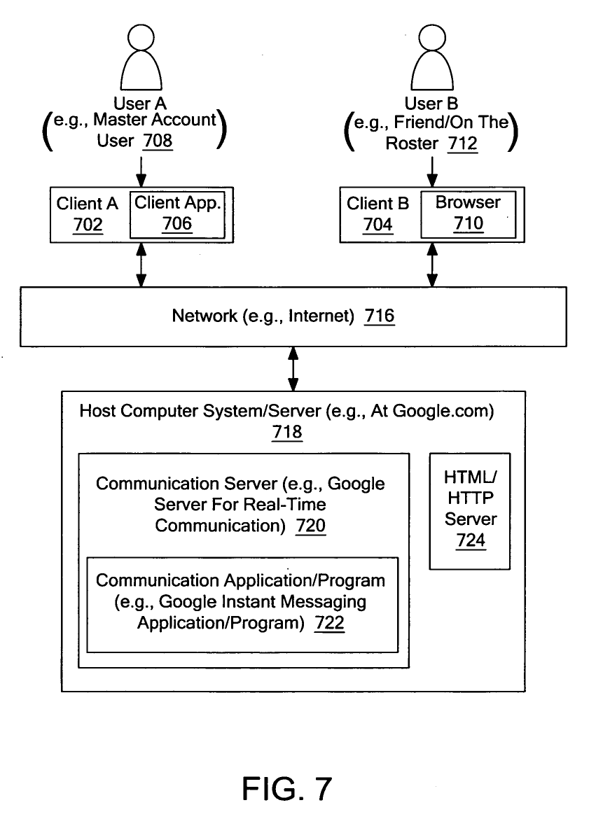

FIG. 7 illustrates an example of an embodiment of proxy-based file sharing. As an initial matter, it is to be noted that FIG. 7 is illustrated merely as an example and thus the embodiment of the present invention are not limited to the architecture provided here. In the illustrated example, user A 708 uses a master account (e.g., instant messaging account) by accessing client A 702, which is in communication with a host server computer system (host server) 718, such as Google's server system (e.g., via the website, Google.com), over a network 716 (e.g., the Internet). User A 708 may be in communication with User B 712 over the network 716. User B 712 may be a friend on the roster of User A 708 and communicatively coupled with client A 702 through client B 704. Client A 702 and client B 704 may make initial contact with each other through communication server 720 located at host server 718.

In one embodiment, the host server 718 employs one or more communication systems or servers (communication server) 720 (e.g., Google server for real-time communication) that can be used for providing, maintaining, and managing real-time communication between various clients 702, 704. The communication server 720 hosts one or more communication applications/programs (communication application) 722 (e.g., Google instant messaging application/program) which provide various modules, controls, and interfaces to help facilitate instant/real-time communication between various clients 702, 704 in communication with each other via the host server 718 over a network 716. It is contemplated that although the communication accounts for users A and B 708, 712 are created, maintained, and managed at the server 718, it is not necessary to do so.

For example, communication accounts for any of the users A and B 708, 712 may have been created at another server, such as at a Google partner server providing instant messaging/real-time communication accounts, and then registered with the host server 718 at Google.com. Further, the communication accounts may not be limited to text instant messaging and may also include emails and other forms of instant messaging (e.g., voice, pictures, videos, etc.). It is contemplated, and as described elsewhere in this document, the network communication between various entities (e.g., server 618, clients A and B 702, 704) is performed through a combination of one or more of WAN, LAN, MAN, PAN, Internet, Intranet, Bluetooth, and the like.

Client A 702 may include a file sharing application 706 locally at its terminal. In one embodiment, User A 708 may seek to share files directly with User B 712 over the network 716. However, User B 712 may not possess a file sharing application 706 at its terminal. On the other hand, User B 712 may have a browser application 710 at its terminal. In order to facilitate direct file sharing between Users A and B 708, 712, host server 718 creates a direct communication connection (e.g., peer-to-peer connection) between Client A 702 and server 718. In this way, Client A 702 may directly send files to share with Client B 704 to server 718.

Server 718 may then post the shared files in an accessible format for Client B 704 to view. In one embodiment, server 718 uses a HTML/HTTP server 724 to create a browser interface to post the shared files. Server 718 may send this browser interface to Client B 704 to view through browser application 710. A proxy-base file sharing session is thereby enabled. In some embodiments, the browser interface provided to Client B 704 emulates the features of the file sharing application 706 located at Client A 702.

In one embodiment, Client B 704 is able to share files with Client A 702 via the browser interface provided by server 718. Furthermore, additional features may be added to the browser interface through Flash, Java, and other browser plug-ins. In some embodiments, another ubiquitous program, such as Windows Media Player, Realplayer, or Quicktime may be used instead of a browser 505 depending on the type of file sharing.

Various sets of content are provided as the documents for file sharing. Users A and B 708, 712 may choose to view the information provided by or contained in the document and use it for a variety of tasks. As described above, the information may be shared using a variety of mediums, such as toolbars (e.g., Google Toolbar), blogs (e.g., Google Blogger), photo processing applications (e.g., Picasa Photo Organizer), emails (e.g., Gmail.com), and the like.

For example, using a photo processing application (e.g., Picasa Photo Organizer) at the server 718, the file sharing is enabled to User B 712 at Client B 704 via (1) an email (e.g., Picasa email, etc.), (2) an image file (e.g., Joint Photographic Experts Group (JPEG) file, Tagged Image File (TIF), TIF Format (TIFF) file, BitMaP (BMP) file, Graphic Interchange Format (GIF) file, Photoshop (PSD) file, Portable network Graphics (PNG) file, etc.), (3) a video file (e.g., Audio Video Interleaved (AVI) file, Moving Pictures Experts Group (MPEG) file, Advanced Systems Format (ASF) file, Windows Media Video (WMV) file, etc.), (4) a slideshow (e.g., Loop slideshow, MPEG Audio Layer 3 (MP3) slideshow, etc.), (5) a message (e.g., an automatic or manual online message/update, a message/update when starting the system, a desktop icon, special effects, etc.), and the like. It is contemplated that different and/or additional programs, components, modules, tools, interfaces, and techniques may be implemented when using different applications (e.g., using Picasa Photo Organizer instead of using the illustrated Google Instant Messaging Application/Program 722) at the server 718 to achieve compatibility and performance.

In one embodiment, server 718 or Client A 702 may work to provide a downlevel progress view to Client B 704 when Client B 704 is viewing or sharing files transmitted by Client A 702. For example, even though Client B 704 views shared files through a browser 710, Client B 704 may view thumbnails of JPEGs before and without having to download the entire JPEG file. Similarly, Client B 704 may hear clips of MP3s, or at least view information regarding the MP3 file such as title, artist, and other metadata. Either server 718 or Client A 702 may provide previews of the files to Client B 704 in such a way that a browser 710 can display. Furthermore, contents of zip files, archives, or directories may be visible and explorable by Client B 704 without having to download the entire file. In some cases, browser 710 at Client B 704 may not have the ability to provide file previews in a proprietary way. The server 718 or Client A 702 may work to provide client B 704 with views of this data in terms of compressed GIFs, JPEGs, HTML, or Javascript, for example.

### Client and Server Architecture/Hardware

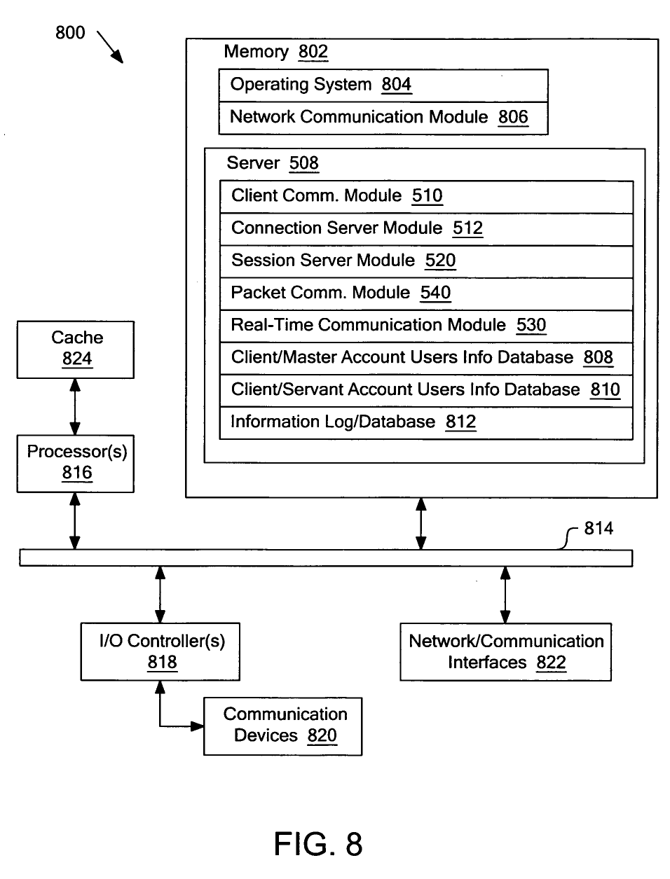

FIG. 8 illustrates an embodiment of a server architecture 800. While FIG. 8 illustrates various components of a computer system, it is not intended to represent any particular architecture or manner of interconnecting the components as such details are not germane to the present invention. Other systems that have fewer or more components may also be used.

The illustrated embodiment of the server architecture 800 includes an inter-connect 814 (e.g., bus and system core logic) to interconnect memory 802 and one or more processors 816, which are coupled with cache memory 824. The inter-connect 814 interconnects the processor 816 and the memory 802 together and further interconnects them to one or more communication devices 820 via one or more input/output (I/O) controllers 818. The inter-connect 814 may include one or more buses coupled with one another through various bridges, controllers, and/or adapters. In one embodiment, the I/O controller 818 includes a USB adapter for controlling USB peripherals, an IEEE-1394 bus adapter for controlling IEEE-1394 peripherals, and the like.

The memory 802 may include Read Only Memory (ROM), volatile Random Access Memory (RAM), and non-volatile memory, such as hard drive, flash memory, etc. Volatile RAM is typically implemented as dynamic RAM (DRAM) which requires power continually in order to refresh or maintain the data in the memory. Non-volatile memory typically includes a magnetic hard drive, a magnetic optical drive, or an optical drive (e.g., DVD RAM), or other type of memory system which maintains data even after power is removed from the system. The non-volatile memory can also include a random access memory although this is not required. Further, the non-volatile memory can include a local device coupled directly to the rest of the components in the data processing system. A non-volatile memory that is remote from the system, such as a network storage device coupled to the data processing system through a network interface such as a modem or Ethernet interface, can also be used.

The memory 802 stores an operating system 804, which may include a network communication module 806. The operating system 804 may include procedures for handling various basic system services and for performing hardware dependent tasks. Examples of the operating system 804 include LINUX, UNIX, Windows, OS/390, OS/400, and the like. The network communication module 806 is configured with a host/computer name and an internet protocol (IP) address and stores a media access control (MAC) address (821) of a network interface device. The network communication module 806 may include instructions used for connecting the server architecture 800 to other computers via wired and/or wireless network/communication interfaces 822, such as the Internet, WAN, LAN, MAN, and the like.

In one embodiment, the server architecture 800 includes a server 508 having a real-time communication management server (e.g., for providing and managing IM communication), a data processing server (e.g., for data collecting and processing), an information communication server (e.g., for communicating information), an information processing server (e.g., for processing information), a query server (e.g., for receiving or forming queries based on the information received), a prediction server (e.g., for returning predictions based on the queries received or formed at the query server), and the like.

In the illustrated embodiment, the server 508 includes various elements, sub-elements, modules, and sub-modules for performing various tasks relating to communicating and processing of information. For example, the server 508 may include a client communication module 510 to facilitate real-time/non-real-time communication of information with various computer systems. The server 508 includes connection server module 512 working in communication with session server module 520 via a packet communication module 540. The server 508 further includes real-time communication module 530.

The server 508 further provides client/master account user information database 808, client/server account user information database 810, and information log/database 812. The client/master account user information database 808 refers to a database containing information relating to one or more clients and one or more users accessing such clients using master communication accounts. Such information may have been provided by the clients and/or users. This information, for example, may be used to generate user and/or client profiles for the purpose of creating master communication accounts. Similarly, client/server account user information database 810 refers to a database containing information relating to one or more clients and one or more users accessing such clients using servant communication accounts. Such information may also be provided by the clients and/or users. The information may be used to generate user and/or client profiles for generating servant accounts.

The information log/database 812 maintains a variety of information that serves as a historical reference when receiving, processing, and transmitting information. For example, information log/database may include a list of historically popular keywords and queries, client/user preferences, log of servant account activities, master/servant account usage history, and the like. It is contemplated that the server 508 may include additional or fewer modules (e.g., the server 508 may include a spelling module to verify spellings of keywords) and that many of the tasks may be delegated to separate modules (e.g., a transmission module performs transmission of information, and a reception module performs reception of information). Further, it is contemplated that more than one server 508 may be used, as preferred or necessitated.

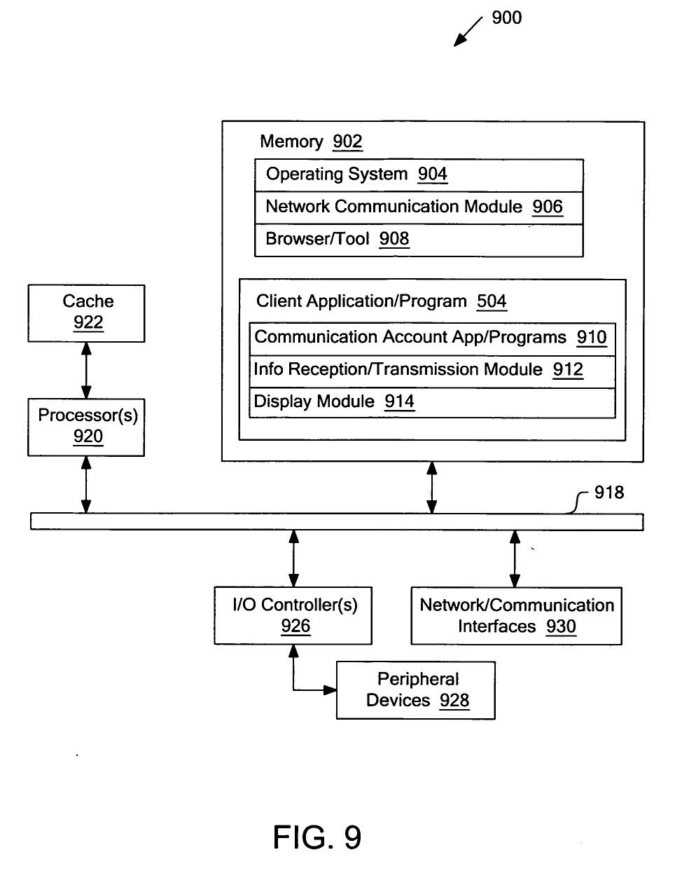

FIG. 9 illustrates an embodiment of a client architecture 900. While FIG. 9 illustrates various components of a computer system, it is not intended to represent any particular architecture or manner of interconnecting the components as such details are not germane to the embodiments of the present invention. Other systems that have fewer or more components may also be used with the present invention. For example, a system in the form of personal digital assistant (PDA) or cellular phone can be configured in a similar way for use with embodiments of the present invention. Further, some components described above with reference to FIG. 8 can also be employed in FIG. 9

In the illustrated embodiment, the client architecture 900 includes an inter-connect 918 coupling a memory 902 with one or more processors 920 coupled with cache memory 922. The inter-connect 918 connects the processors 920 and memory 902 to one or more display controllers and devices 924 and to one or more peripheral devices, such as I/O devices 928, through one or more I/O controllers 926. The peripheral devices 928 include keyboards, mice, modems, network interfaces, printers, scanners, video cameras, disks, fax machines, graphics tablets, joysticks, paddle I/O controllers, and the like. The inter-connect 918 further connects additional one or more network and communication interfaces 930.

The memory 902 stores an operating system 904, a network communication module 906, and a browser/tool 908. The operating system 904 may include procedures for handling various basic system services and for performing hardware dependent tasks. Examples of the operating system 904 include LINUX, UNIX, Windows, OS/390, OS/400, and the like. The network communication module 906 may include instructions that are used for connecting the client architecture to other computers via the communication network interfaces 930 and communication networks, such as the Internet, LAN, WAN, MAN, and the like. The browser or tool 908 is used for providing interfacing with a user to input requests, preferences, queries, and to display the documents containing offerings. The browser or tool 908 may include graphical user interface (GUI)-based tools and/or a web browsers, such as Microsoft Explorer, Netscape Navigator, and the like.

The memory 902 further stores a client application or program 504 that is independently obtained or downloaded onto the client from a server. In one embodiment, the client application 504 is a file sharing application that further includes a communication account application/program 910, information reception/transmission module 912, and a display module 914.

### General

Throughout the foregoing description, for the purposes of explanation, numerous specific details are set forth in order to provide a thorough understanding of the embodiments of the present invention. It should be apparent, however, to one skilled in the art that the embodiments of the present invention may be practiced without some of these specific details. In other instances, well-known structures and devices are shown in block diagram form to avoid obscuring the underlying principles of the present invention. References to one or an embodiment in the present disclosure are not necessarily references to the same embodiment; and, such references mean at least one.

The description and drawings are illustrative and are not to be construed as limiting the invention. Although some of various drawings illustrate a number of logical stages in a particular order, stages which are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache, a remote storage device, and the like.

In various embodiments, hardwired circuitry may be used in combination with software instructions to implement the present invention. Thus, the techniques are not limited to any specific combination of hardware circuitry and software or to any particular source for the instructions executed by the data processing system.

In addition, throughout this description, various functions and operations are described as being performed by or caused by software code to simplify description. However, those skilled in the art will recognize what is meant by such expressions is that the functions result from execution of the code by a processor, such as a microprocessor.

A machine-readable medium can be used to store software and data which when executed by a data processing system causes the system to perform various methods of the present invention. This executable software and data may be stored in various places including for example ROM, volatile RAM, non-volatile memory, cache, and the like. Portions of this software and/or data may be stored in any one of these storage devices.

Thus, a machine-readable medium includes any mechanism that provides (i.e., stores and/or transmits) information in a form accessible by a machine (e.g., a computer, network device, personal digital assistant, manufacturing tool, and any device with a set of one or more processors). For example, the machine-readable medium may include, but is not limited to, floppy diskette, optical disk, compact disk-ROM (CD-ROM), magneto-optical disk, ROM, RAM, erasable programmable ROM (EPROM), electrically erasable programmable ROM (EEPROM), magnetic or optical storage media, flash memory devices, electrical, optical, acoustical or other forms of propagated signals, such as carrier waves, infrared signals, digital signals, and another type of media/machine-readable medium suitable for storing electronic instructions.

Various methods are described and also are described forms of apparatus, which perform these methods, including data processing systems which perform these methods, and computer-readable media which when executed on data processing systems cause the systems to perform these methods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
establishing a peer to peer connection with a remote client through a server using a file sharing application at the remote client;
generating a document having a network address;
receiving a file from the remote client through the file sharing application;
posting the received file on the document; and
sending the document with the posted file to a second remote client.

2. The method of claim 1, wherein the server comprises an Extensible Messaging and Presence Protocol (XMPP) server.

3. The method of claim 1, wherein the file is selected from the group including a graphics file, a music file, and a video file.

4. The method of claim 1, wherein the document comprises a HyperText Markup Language (HTML) page.

5. The method of claim 1, wherein sending the document further comprises sending a preview of the document.

6. The method of claim 1, wherein sending the document further comprises receiving a request from the second remote client through a web browser.

7. The method of claim 6, further comprising sending the network address to the second remote client.

8. The method of claim 7, further comprising generating a browser interface to the second remote client that emulates the features of the file sharing application.

9. The method of claim 8, further comprising receiving a file from the second remote client to share with the first remote client through the browser interface.

10. The method of claim 1, further comprising establishing a real-time communication connection between the first and second remote clients in order to initiate the peer to peer connection.

11. A system comprising:
means for establishing a real-time communication connection between a first remote client and a second remote client through a first server to enable file sharing between the first and second remote clients;
means for establishing a peer to peer connection between the first remote client and a second server through the first server by utilizing a file sharing application at the first remote client;
means for receiving a file from the file sharing application of the first remote client at the second server through the peer to peer connection;
means for posting the received file on a document generated at the second server; and
means for sending the document with the posted file from the second server to the second remote client.

12. The system of claim 11, wherein the first server comprises an Extensible Messaging and Presence Protocol (XMPP) server.

13. The system of claim 11, wherein the means for sending the document further comprises means for sending a network address associated with the document to the second remote client.

14. The system of claim 13, further comprising means for generating a browser interface for the second remote client that emulates the features of the file sharing application.

15. The system of claim 11, wherein the file is selected from the group including a graphics file, a music file, and a video file.

16. A machine-readable medium having stored thereon data representing sets of instruction which, when executed by a machine, cause the machine to:
establish a real-time communication connection between a first remote client and a second remote client to enable file sharing between the first and second remote clients; and
receive a document at the first remote client from a server with a peer to peer connection with the second remote client;
wherein the document includes a file sent to the server from the second remote client to be shared with the first remote client.

17. The machine-readable medium of claim 16, wherein the server comprises an Extensible Messaging and Presence Protocol (XMPP) server.

18. The machine-readable medium of claim 16, wherein the file is selected from the group including a graphics file, a music file, and a video file.

19. The machine-readable medium of claim 16, wherein the document comprises a HyperText Markup Language (HTML) page.

20. The machine-readable medium of claim 19, wherein the set of instructions which, when executed by the machine, further cause the machine to view the document using a browser interface at the first remote client.
